(19) United States
(12) Patent Application Publication
(10) Pub. No.: US 2020/0327304 A1
(43) Pub. Date: Oct. 15, 2020

(54) SYSTEM AND METHOD FOR RAPIDLY LOCATING IRIS USING DEEP LEARNING

(71) Applicant: Yung-Hui Li, Taichung City (TW)

(72) Inventor: Yung-Hui Li, Taichung City (TW)

(21) Appl. No.: 16/405,147

(22) Filed: May 7, 2019

(30) Foreign Application Priority Data
Apr. 9, 2019 (TW) 108112339

(51) Int. Cl. G06K 9/00; G06K 9/62

(52) U.S. Cl. CPC G06K 9/0061; G06K 9/00617; G06K 9/6262; G06K 9/00604

(57) ABSTRACT

A system and method for rapidly locating iris using deep learning. The system consists of a lighting unit, an image capture module and a controlling and processing module. Particularly, there are an eye pattern determining unit, an inner boundary estimating unit and an outer boundary estimating unit provided in the controlling and processing module. The eye pattern determining unit is used for determining an eye candidate region from an eye image frame, and the inner boundary estimating unit and the outer boundary estimating unit are configured for respectively determining an inner boundary and an outer boundary of an iris. Moreover, experimental data have proved that, the system of the present invention is able to find out and locate an iris region from an image frame containing an eye pattern within 0.06 seconds by an accuracy of at least 95.49%.

### CROSS REFERENCE TO RELATED APPLICATION

This application claims priority to Taiwan Patent Application No. 108112339. The entire contents of the above applications is hereby incorporated by reference. The entire contents of the above applications and its appendix are hereby incorporated by reference.

### BACKGROUND

### 1. Technical Field

Aspects of the present invention relates to the technology field of biometric identification, and more particularly to a system and method for rapidly locating iris using deep learning.

### 2. Description of the Prior Art

Biometrics technology is used to achieve an individual identification through human characteristics, wherein the human characteristics are mainly classified into physical characteristics and behavioral traits. The physical characteristics are known including fingerprint, palm print, veins distribution in human hands, iris, retina, and facial features. On the other hand, behavioral traits are voice print and signature. In the case of fully considering the false acceptance rate (FAR) and the false rejection rate (FRR), iris recognition is nowadays recognized as the most potential technology available for biometric identification of individuals. Features extracted from iris texture in left eye have been determined to be different from that of iris texture in right eye. It is worth noting that, to produce or make a copy of a specific iris texture has been proved to be impossible because even identical twins have similar but not identical features of iris texture. Moreover, comparing to the fact that there are around 80 facial feature points and 20-40 fingerprint feature points can be extracted from a person, the feature points extracted from the iris texture of the person could be up to 244. Therefore, it is understood that the iris recognition should be one kind of biometrics technology having the highest accuracy and security.

U.S. patent publication No. 2015/0131051 A1 has disclosed an eye detecting device, and FIG. 1 illustrates a framework diagram of the conventional eye detecting device. There is an electronic device 1′ installed with an iris recognition application program provided in FIG. 1. When the iris recognition application program is activated, the electronic device 1′ is operated to irradiate an infrared light to one eye 2′ of an individual by using a lighting unit 11′ thereof, such that the iris recognition application program is able to subsequently obtain an eye image by using a camera 12′ of the electronic device 1′. Under the illumination of the infrared light, the iris recognition application program can define a survey area M′ which encloses at least one glint G′ reflected from iris 21′ of the eye 2′. Consequently, the iris recognition application program can locate pupil 22′ from the eye 2′ after finishing a grayscale value comparison between the survey area M′ and an adjacent area near the survey area M′.

The conventional eye detecting device disclosed by U.S. patent publication No. 2015/0131051 A1 is found failing to locate pupil 22′ and/or iris 21′ from one human eye 2′ efficiently and rapidly. In most cases, the iris recognition application program is hard to find out the pupil 22′ and locate the iris 21′ from the eye 2′ because an outer boundary of the pupil 22′ and/or the iris 21′ is covered by eyelashes 23′ and eyelids 24′. Moreover, noise signals produced by reflective light spots also cause the iris recognition application program cannot locate pupil 22′ and/or iris 21′ from the eye 2′ efficiently and rapidly.

From above descriptions, it is easily known that there is a room for improvement in the iris recognition technology proposed by U.S. patent publication No. 2015/0131051 A1. In view of that, the inventor of the present application have made great efforts to make inventive research and eventually provided a system and method for rapidly locating iris using deep learning.

### SUMMARY

The primary objective of the present invention is to provide a system and method for rapidly locating iris using deep learning, wherein the system consists of a lighting unit, an image capture module and a controlling and processing module. Particularly, there are an eye pattern determining unit, an inner boundary estimating unit and an outer boundary estimating unit provided in the controlling and processing module. Moreover, the eye pattern determining unit is used for determining an eye candidate region from an eye image frame, and the inner boundary estimating unit and the outer boundary estimating unit are configured for respectively determining an inner boundary and an outer boundary of an iris. It is worth particularly explaining that, experimental data have proved that, the system of the present invention is able to find out and locate an iris region from an image frame containing an eye pattern within 0.06 seconds by an accuracy of at least 95.49%.

In order to achieve the primary objective of the present invention, the inventor of the present invention provides an embodiment of the system for rapidly locating iris using deep learning, comprising:

at least one lighting unit for emitting an infrared light to at least one eye;

at least one image capture module, being adopted for applying an image capturing process to the at least one eye in the case of the at least one eye being under the illumination of the infrared light; and

a controlling and processing module, being coupling to the at least one lighting unit and the at least one image capture module, so as to receive at least one eye image frame transmitted from the image capture module; the controlling and processing module comprising:

an eye pattern determining unit for determining an eye candidate region from the eye image frame;

an inner boundary estimating unit, being coupled to the eye pattern determining unit, and being configured for applying an inner boundary estimating process to the eye candidate region, so as to determine an inner boundary of an iris; and

an outer boundary estimating unit, being coupled to the inner boundary estimating unit, and being configured for applying an outer boundary estimating process to the eye candidate region, so as to determine an outer boundary of the iris.

Moreover, for achieving the primary objective of the present invention, the inventor of the present invention provides one embodiment of the method for rapidly locating iris using deep learning, comprising following steps:
(1) letting at least one lighting unit emit an infrared light to at least one eye;
(2) using at least one image capture module to apply an image capturing process to the at least one eye under the at least one eye being in the illumination of the infrared light;
(3) providing a controlling and processing module having an eye pattern determining unit, an inner boundary estimating unit and an outer boundary estimating unit, and receiving the at least one eye image frame from the image capture module by using the controlling and processing module;
(4) determining an eye candidate region from the eye image frame by using the eye pattern determining unit;
(5) using the inner boundary estimating unit to apply an inner boundary estimating process to the eye candidate region, so as to obtain an inner boundary of an iris; and
(6) using the outer boundary estimating unit to apply an outer boundary estimating process to the eye candidate region, so as to obtain an outer boundary of the iris.

### BRIEF DESCRIPTION OF THE DRAWINGS

The invention as well as a preferred mode of use and advantages thereof will be best understood by referring to the following detailed description of an illustrative embodiment in conjunction with the accompanying drawings, wherein:

FIG. 1 shows a framework diagram of a conventional eye detecting device disclosed by U.S. patent publication No. 2015/0131051 A1;

FIG. 2 shows a framework diagram of a system for rapidly locating iris using deep learning according to the present invention;

FIG. 3 shows an architecture of CNN used in present invention;

FIGS. 4a, 4b, 4c, 4d, 4e, 4f, 4g and 4h show eight types of Gabor filters used to extract features;

FIG. 5 shows the process of pupillary region prediction;

FIGS. 6a, 6b and 6c show the procedure for finding the pupillary boundary points;

FIGS. 7a, 7b, 7c and 7d show results of pupillary boundary estimation;

FIG. 8 shows a length L1 and L2, which are derived from Faster R-CNN;

FIG. 9 shows an illustration of boundary pint selection problem;

FIGS. 10a, 10b, 10c, 10d, 10e, and 10f illustrate boundary points selection process of a sophisticated algorithm;

FIGS. 11a, 11b, and 11c show a manually labeled region information of the iris;

FIGS. 12a, 12b, 12c, 12d, 12e, 12f, 12g, 12h, and 12i show a performance comparison between SVM and GMM;

FIGS. 13a, 13b, and 13c show a performance evaluation of segmentation;

FIGS. 14a and 14b show the histogram of the q values for evaluating the segmentation performance on the full-CASIA-Iris-Thousand database;

FIG. 15 shows a function block diagram of the system for rapidly locating iris using deep learning;

FIG. 16 shows a flowchart diagram of the method for rapidly locating iris using deep learning according to the present invention;

FIG. 17 shows a diagram for describing the inner framework of an eye pattern determining unit, an inner boundary estimating unit and an outer boundary estimating unit.

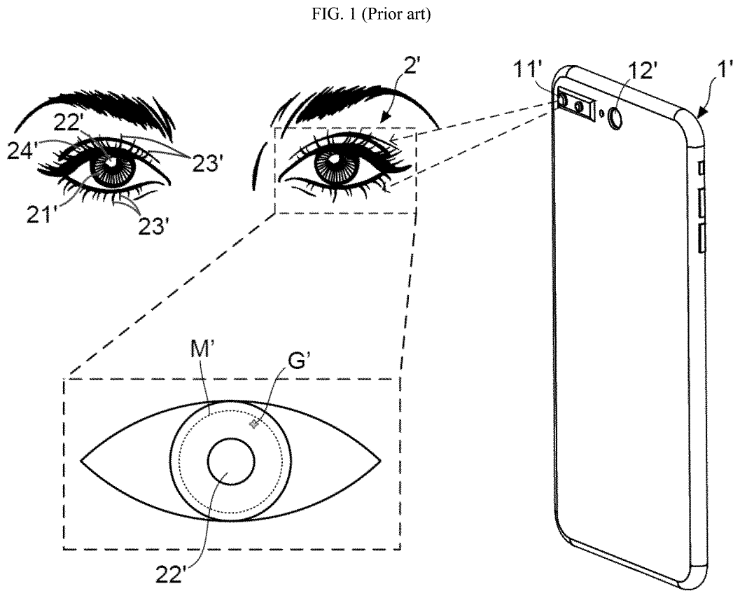

### DETAILED DESCRIPTION

To more clearly describe a system and method for rapidly locating iris using deep learning disclosed by the present invention, embodiments of the present invention will be described in detail with reference to the attached drawings hereinafter.

Having described the invention in detail, it will be apparent that modifications and variations are possible without departing from the scope of the invention defined in the appended claims. The following non-limiting examples are provided to further illustrate the present invention.

The algorithm proposed in this paper consists of three key steps: eye detection, pupillary boundary estimation, and limbus boundary estimation. We used a Faster R-CNN model to detect the location of an eye in an image. Then, the pupillary and limbus boundaries were found using GMM, maximization of the intensity gradient along the radial emitting path (MIGREP), and boundary point selection algorithms. Thus, the iris region was accurately located.

Eye Detection.

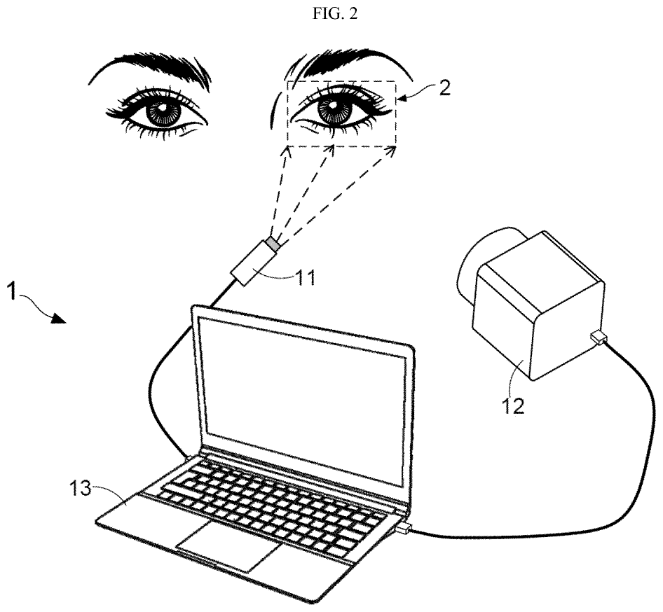

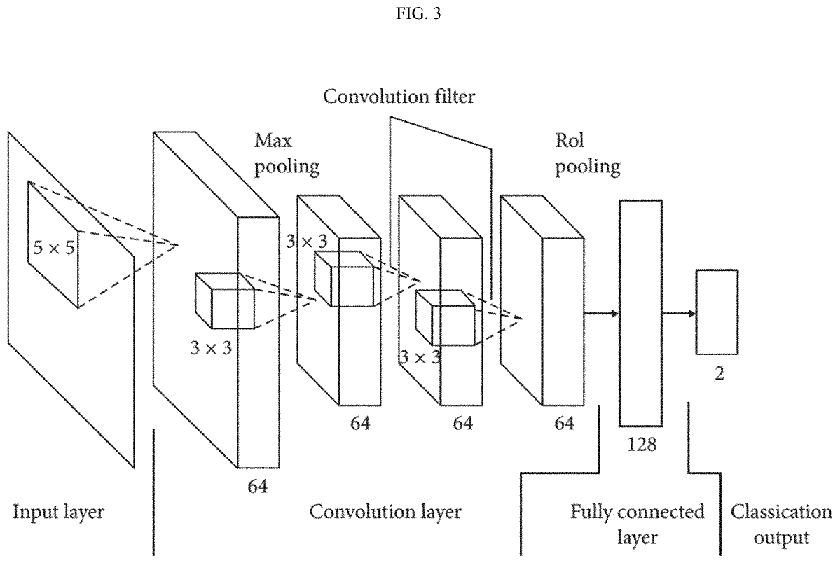

The first step to segment the iris region is to find (detect and locate) the eye in an image. As the task of detecting only two classes, eye or background, in an image is simple, the architecture of CNN in Faster R-CNN does not require very deep convolutional layers. In this study, the original CNN, Zeiler and Fergus (ZF) model or Simonyan and Zisserman model (VGG-16), and a newly designed network. As depicted in FIG. 3, the network contained only six layers. The first convolution layer filtered the grayscale input image with 64 kernels of size 5×5×1 with a stride of one pixel. It was followed by a rectified linear unit (ReLU) layer and a local response normalization (CN) layer, which ran over five adjacent kernel maps at the same spatial position. A max-pooling layer with a two-pixel gap between the centers of neighborhood pooling units of size 2×2 followed the normalization layer. The second, third, and fourth convolution layers had 64 kernels of size 3×3×64. A batch normalization (BN) layer and a ReLU layer were applied after the second, third, and fourth layers. The reason we use batch normalization and ReLU is because it reaches the same error rate faster compared to other activation functions such as Tanh function, which means we can train the neural network faster and acquire more neural network models with different parameters. Also, the speed of the model will be faster than other traditionally used activation functions.

The RoI pooling layer extracted a 1024-dimensional feature vector from the output feature maps of the final convolutional layer. The fully connected layer had 128 neurons, and its output that after passing through an ReLU layer was fed to a softmax layer to generate a distribution between the two class labels.

Gaussian Mixture Model.

After generating the potential eye regions with Faster R-CNN, only one bounding box with the maximum score of the eye class and an appropriate aspect ratio was selected to fit the pupillary region. Originally, we planned to use another Faster R-CNN model trained specifically for detecting the pupillary region. However, the result is not as accurate as the model for eye region, and the execution time of two Faster R-CNN models is not fast enough for a real-time iris recognition system. So, we decided to use the Gaussian mixture model as our pupillary detection method.

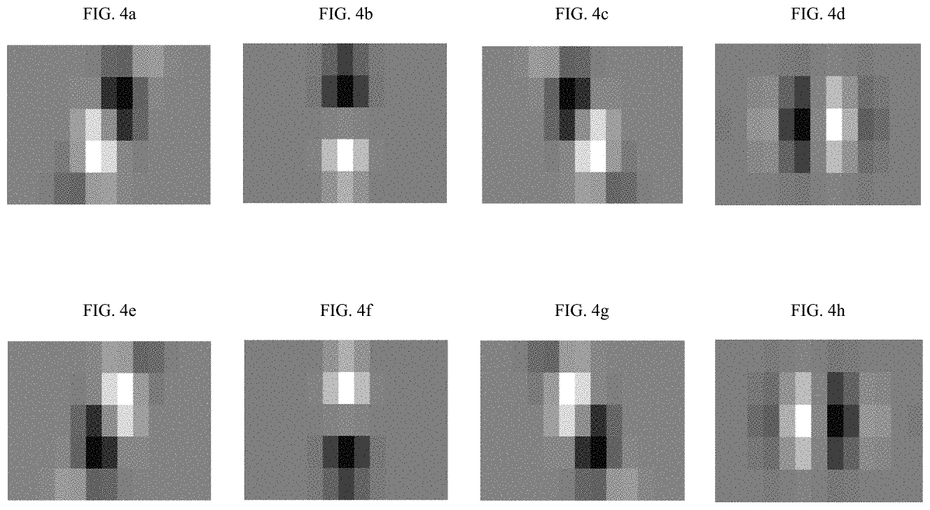

The GMM was built using the expectation maximization (EM) algorithm based on a set of features including the normalized coordinates of pixels, pixel values filtered by a local median of kernel size 5×5, and pixel values filtered using Gabor filters (see FIG. 4). A GMM was parameterized by mixture component weights, component means, and covariance matrices. For a GMM with K components, the k^{th} component had the mean μₖ and the covariance matrix Σₖ. The posterior probability distribution can be expressed using the following equations:

$$\begin{matrix}p ( θ \vert x ) = {\sum }_{i = 1}^{K} {w}_{i} N ( {μ}_{i} , {\sum }_{i} \vert x ) , & ( 1 ) \\ N ( {μ}_{i} , {\sum }_{i} \vert x ) = \frac{1}{\sqrt{{( 2 π )}^{K} \vert {\sum }_{i} \vert}} \cdot exp ( - \frac{1}{2} {( x - {μ}_{i} )}^{T} {\sum }_{i}^{- 1} ( x - {μ}_{i} ) ) , & ( 2 ) \\ {\sum }_{i = 1}^{K} {w}_{i} = 1 , & ( 3 )\end{matrix}$$

Where θ is the parameter set {μ, ω, Σ}. The mixture component weight was defined as ωᵢ, and its total number of K components was normalized to one μᵢ, and Σᵢ are mean and covariance matrix of the component i, with a total number of K. In the training stage, the model was trained using the EM algorithm, which is a type of maximum likelihood estimation techniques. The EM algorithm for GMM consists of two steps. The first step, known as the expectation step or E step, is to calculate the expectation of the component Cₖ for each datum Xᵢ∈X, given the model parameters ωₖ, μₖ, and Σₖ. The second step is known as the maximization step or M step, which is needed to maximize the expectations calculated in the E step with respect to the model parameters and to update the values ωₖ, μₖ, and Σₖ. The entire iterative process repeats steps 1 and 2 until the algorithm converges on the maximum likelihood estimation. As the number of components K is not a known priori parameter in this task, the method like “unsupervised learning of finite mixture models” may be used to adjust the K value automatically during the training stage.

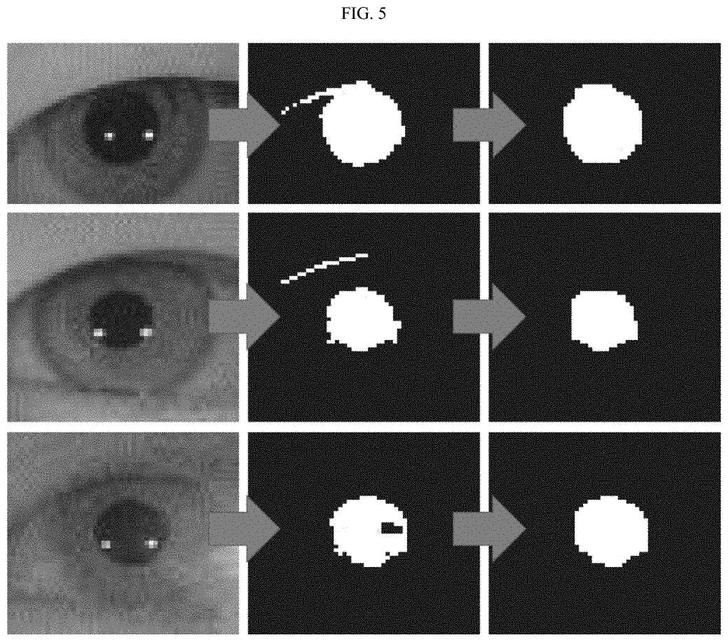

Pupillary Boundary Estimation. A well-trained GMM can fit the pupillary region inside the region proposal. In general, the result shows a unique candidate pupillary region in each image. However, in some situations, the GMM fits multiple regions consisting of the pupillary region, eyelashes, eyelids, specular reflections, and noisy points. We used a three-step process with three image processing methods (grouping, filling, and morphology opening) to discard the noisy regions and were left with only one candidate pupillary region. As shown in FIG. 5, each row presents one test eye image. The left column presents the region proposals produced from Faster R-CNN. The median column presents the candidate pupillary regions predicted by the GMM. Further, the right column presents the final smooth region after applying the image processing methods.

The GMM calculated the probability scores with the eye and the background classes of each pixel in the image. According to this score, several candidate points in the pupillary region could be obtained to smoothen the candidate pupillary region and remove the noisy region. The first step involves grouping regions on the candidate pixels predicted from the GMM using an eight-connected neighborhood algorithm. Then, each sub-region was checked for whether it contained more than 250 pixels, and the longer axis of its area was less than 1.15 times the shorter axis. The largest sub-region that met the above requirements was considered the pupillary region. If all the regions were outside the specification, the largest region was selected as the pupillary region. Filling the empty space inside the region was the second step. Finally, a morphological opening operator based on a structuring square element of size four was applied to smoothen the region. In the mathematical morphology, the opening operator eroded objects that were smaller than the structuring element and dilated the shape of the remaining region. When empty spaces occurred on the edge of the region, as shown in the bottom row in FIG. 5, the filling step prevented the region passing through the opening operator from generating new cracks. More importantly, the opening operator not only smoothened the pupillary region but also eliminated the noisy points, as shown in the top row in FIG. 5.

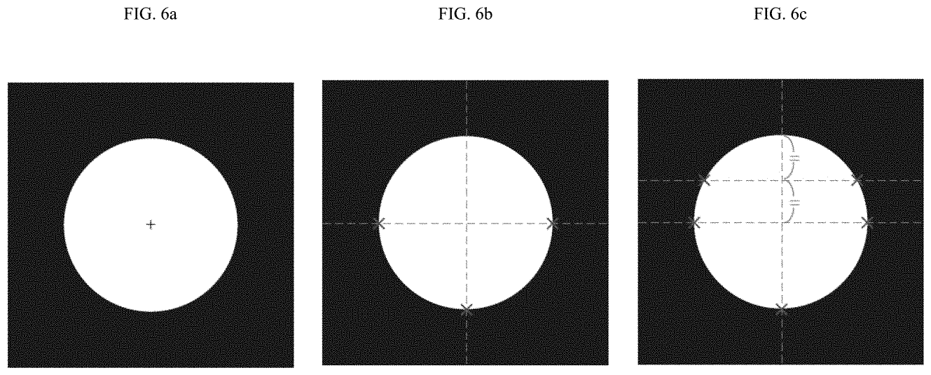

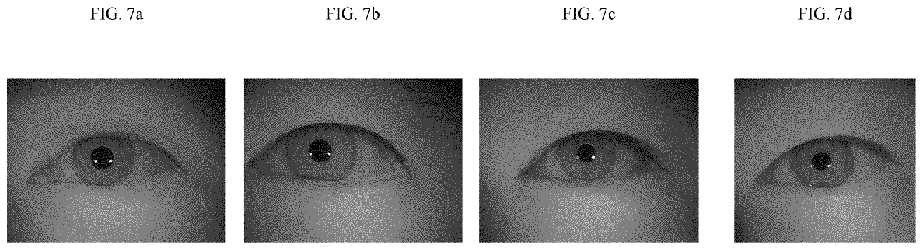

When the pupillary region was drawn up, the coordinates of its center point were easily obtained. To precisely recover the pupillary boundary, a pixel scan of the column and the row was performed at the center point to select the lower, left, and right end points. Because the top end point might be obscured by the upper eyelid, the top point found by the pixel scan was probably different from the actual pupillary boundary point. Instead, two points selected from a new scan performed at the location with the same distance to the center point, and the upper end point was collected. We obtained five key boundary points through the pixel scan methods. The full procedure is shown in FIGS. 6a, 6b and 6c. FIG. 6a shows a circle and its center. FIG. 6b shows a pair of horizontal and vertical lines crossing a center and three boundary points. FIG. 6c further shows another horizontal lines and additional two boundary points. After obtaining the five boundary points, each point was denoted according to its coordinates as (xᵢ,yᵢ). It completely collected five pairs of coordinates of pupillary boundary points. The parameters of an approximate circle are computed using Equation (4). Moreover, the circle with the computed circle parameters could be accurately located on the pupillary boundary, as shown in FIGS. 7a, 7b, 7c and 7d.

$$\{ x , y , r \} = arg {min}_{x , y , r} {\sum }_{i = 1}^{N} {( {x}_{i} - x )}^{2} + {( {y}_{i} - y )}^{2} - {( {r}_{i} - r )}^{2} . \qquad ( 4 )$$

Limbus Boundary Estimation.

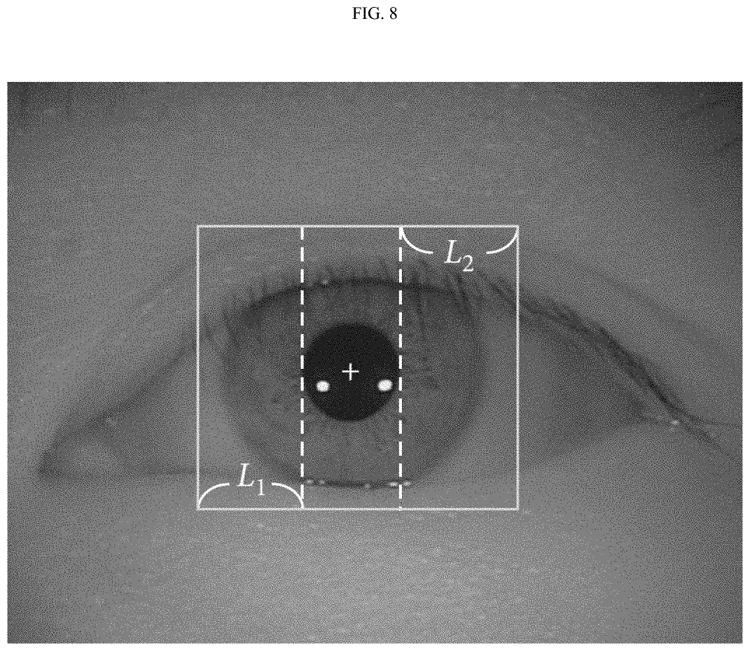

The limbus boundary was estimated after the pupillary region, and its boundary was located. The enhanced version of MIGREP was applied for estimating the coarse limbus boundary. Its required work was to design a few radially emitting paths that went outward from the pupillary center. Hence, the parameters of two distances had to be defined in advance. One, called S₁, was the distance between the starting points of the emitting paths and the pupillary center. The other was defined as S₂ and represented the distance from the pupillary center to the end points of the emitting paths. In the enhanced version of MIGREP, these two parameters were predefined and cannot adapt to various input images during runtime. In this work, (S₁, S₂) were dynamically adjusted according to the size of the bounding box found by Faster R-CNN. We compared the distances from the edge of the pupillary region to the left and the right sides of the bounding box and selected the shortest one as the basic length, as shown in FIG. 8. The definition of L1 and L2, which are derived based on the localization results from Faster R-CNN. The shortest distance between L1 and L2 will be set as the basic length. Then, S₁ and S₂ were assigned the values of the pupillary radius and further incremented by 0.4 and 1.2 times the basic length, respectively. As the bounding box was located by the learning-based algorithm, the basic length associated with it was robust and adjusted automatically during runtime for each image. Thus, most of the emitting paths were supposed to start from somewhere inside the iris region and stop somewhere in the sclera region.

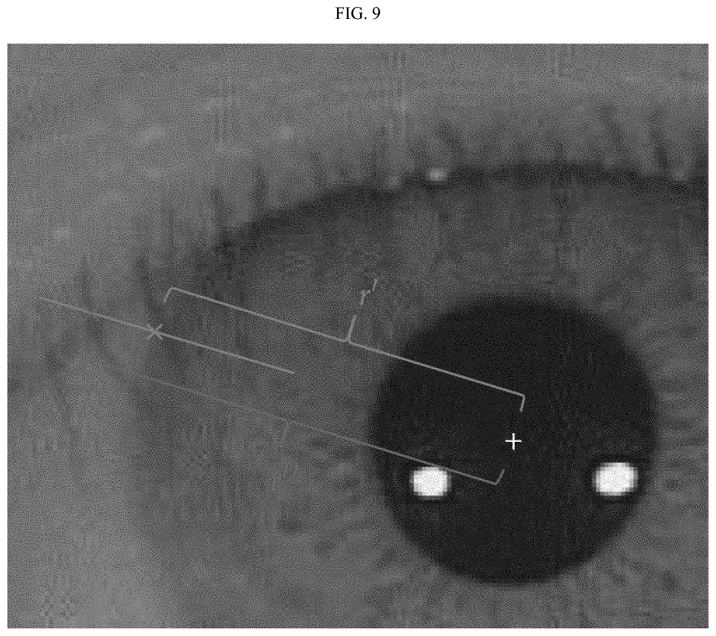

By keeping record of the pixel intensity values along the emitting path, the position that exhibited the maximal variation of pixel intensity was located. This position had to correspond with the intersection between the emitting path and the limbus boundary. Thus, multiple boundary points were successfully estimated when multiple emitting paths were used. Depending on the parameter θ and the shape of the eyelids and the eyelashes, the position showing the maximal value of the intensity gradient was probably not located on the limbus boundary. To solve this problem, we had to consider a set of candidate points where the local maximum gradient occurred, rather than considering only a single point where the global maximum gradient occurred. As depicted in FIG. 9, the gradient value of the red point could be higher than that of the blue one, which denoted incorrect boundary point estimation. Therefore, we had to consider a set of candidate points consisting of red and blue points and then, select the point with the highest likelihood from the set.

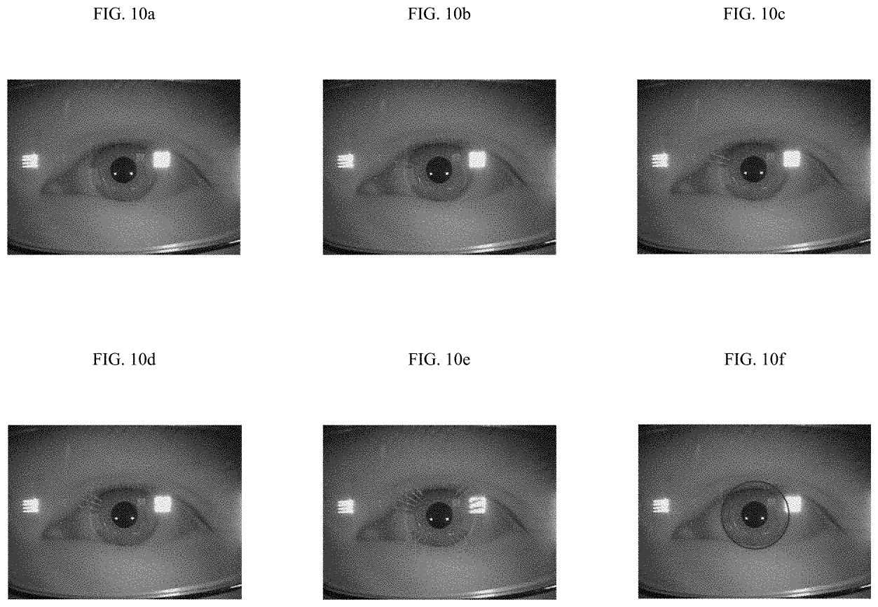

A more sophisticated boundary point selection algorithm was used for this problem. FIGS. 10a, 10b, 10c, 10d, 10e, and 10f illustrate the idea. In FIG. 10a, eleven radial emitting paths are drawn with the parameter θ∈[180°, 210° ] (for the other side θ∈[−30°, 0°]), and the points corresponding to the maximal gradient are recorded. The small circle shows an inner boundary of an iris. The reference value rₘ is determined by taking the median of the distances from these points to the pupillary center. In FIGS. 10(b)-10(e), repeatedly drawing new emitting paths and applying the boundary point selection algorithm result in the correct location of many boundary points. In FIG. 10f, final limbus boundary is recovered by fitting a circle on all candidate points based on Equation (4). The larger circle shows an outer boundary of the iris. First, the eleven emitting paths are drawn with the parameter θ∈[180°, 210°]. For paths with such angles, it is highly likely that the maximal gradient occurred on the limbus boundary, as shown in FIG. 10a. Thus, the median value rₘ of the distances from these points to the pupillary center is recorded as a reference value. Second, a new emitting path (with θ∈[130°, 170°]) is drawn, for which an incorrect boundary point might have the maximal gradient, as shown in FIGS. 10(b)-10(d). In such a case, the corresponding distance values r from the pupillary center to all the points where the local maximal gradient g occurred are respectively recorded. The point that have the larger local maximal gradient value and whose distance value is within ε=2 of the reference value is selected. Taking FIG. 10(b) as an example, assuming that the reference value is rₘ in this runtime, the blue point on the new path will be selected on the basis of Equation (5), instead of the red point.

$$k = {arg max}_{i} ( {g}_{i} \vert \vert {r}_{m} - {r}_{i} \vert < ɛ \qquad ( 5 )$$

Third, after the best candidate point is selected, the reference value rₘ is updated with rₖ, which serves as the new approximate value of the radius for the boundary points close to it. By repeating the above mechanism for the boundary point selection and the distance updating on the next emitting path with a new 0 value ranging from [130°, 240° ] to [−60°, 50°], we gradually adjust the coarse limbus boundary points to more precise locations, as shown in FIG. 10(e). Sometimes, the reflection point of light occurs on the limbus boundary and might cause the iteration of the mechanism to go into a bad evolution. Therefore, the distance updating might not apply to the pixels whose pixel values are larger than those of the normal pixels that had 95% probability in the normal distribution established using the pixel values of the complete image.

### Experimental Results and Discussion

Database.

The database used to train Faster R-CNN and GMM was the CASIA-Iris-Thousand database. This database contains 1,000 subjects with a total of 20,000 iris images, which were collected using the IKEMB-100 camera. As a large number of subjects wore glasses during image capturing, many images have glass frames and specular reflection. These types of obstructions were obstacles to the iris segmentation.

Detection Model Training.

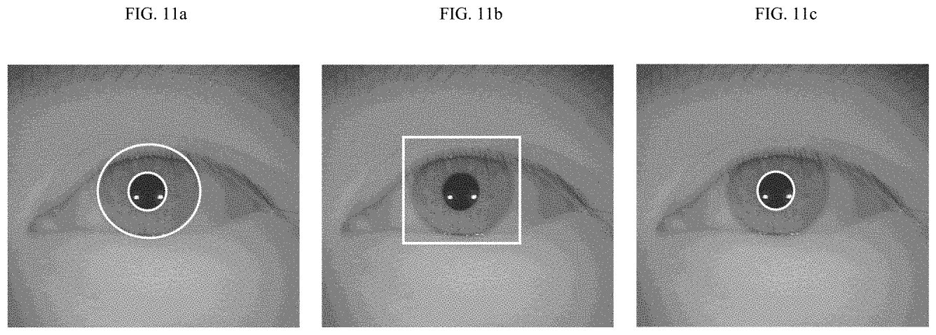

Faster R-CNN and GMM used the full CASIA-Iris-Thousand database for the training and the test. The training set had 6,000 right-eye and 6,000 left-eye images, and the test set had 4,000 right-eye and 4,000 left-eye images. Each image has the region information of the iris that was manually labeled, as shown in FIGS. 11a, 11b and 11c. FIG. 11a shows a manually labeled iris region. In FIG. 11b, the bounding box computed from the circle parameters of the limbus boundary is the region label for training Faster R-CNN. FIG. 11c shows information of the pupillary region used for training GMM. To build the proposed algorithm in a mobile device or an embedded system, the model has to occupy less storage space and has lower computational complexity. The model is trained using the training images, previously reduced to the specified size. However, in the test stage, the test images are resized in runtime to pass through the model. The results of the detection are mapped onto the original test images to ensure that there are sufficient iris textures inside the bounding boxes for use in the other iris recognition steps.

To share the convolutional weights between CNN and RPN in Faster R-CNN, the model has to be trained in four steps. The first step consists of training a region proposal network. For the convolutional feature map of size W×H outputted from the fourth convolution layer of the proposed model, RPN finds the W×H×k potential regions. Using of the last convolution layer as feature map has been applied and proven very effectively by other object detecting convolution neural network such as R-CNN and Faster R-CNN.

However, only 2,000 regions with the higher intersection over union (IoU) value are assigned to positive samples for training the CNN. In the second step, a separate detection network by Fast R-CNN was trained using the region proposals generated from the RPN built in Step 1. At this stage, the two networks did not yet share the convolutional weights. In the third step, the detection network was used to initialize RPN training. It frozed the weights of the shared convolution layers and fine-tuned the layers that belonged only to the RPN during training. The final step was to fine-tune (with the same operation) the layers that only belonged to the CNN. Hence, the networks shared the same convolution layers and merged into a single network.

For the purpose of finding the best architecture of the RPN and CNN model, we trained multiple models with different fine-tuned parameter sets using the right-eye images of the CASIA-Iris-Thousand database, as shown in Tables 1 and 2 below. The new architecture of the CNN model was designed on the basis of VGG-16. As the detection task in this study was simple, we reduced the number of convolution layers of VGG-16. Precision and recall were used to measure the performance of the detector. Precision is the fraction of retrieved objects relevant to the detection, and recall is the fraction of relevant objects successfully retrieved. Here, we set an overlap threshold of IoU=0.8 to select effective detection, which was a strict condition.

TABLE 1
Experimental results of finding the best architecture of CNN.

| | | | | Rol pooling | Fully connected |
|---|---|---|---|---|---|
| | Test time | Input image size | Layers | grid size | layer |
| A | 0.191 s | 480 × 640 | (3 × 3 × 64) × 3 conv_2 | 120 × 120 | 128 → 2 |
| | | | (2 × 2) max pool | | |
| | | | (3 × 3 × 64) × 3 conv_2 | | |
| B | 0.197 s | 480 × 640 | (3 × 3 × 64) × 2 conv_2 | 120 × 120 | 256 → 2 |
| | | | (2 × 2) max pool | | |
| | | | (3 × 3 × 64) × 3 conv_2 | | |
| C | 0.286 s | 480 × 640 | (7 × 7 × 128) × 1 conv_1 | 120 × 120 | 128 → 2 |
| | | | (2 × 2) max pool | | |
| | | | (3 × 3 × 128) × 3 conv_2 | | |
| D | 0.295 s | 480 × 640 | (7 × 7 × 128) × 1 conv_1 | 120 × 120 | 128 → 2 |
| | | | (2 × 2) max pool | | |
| | | | (3 × 3 × 128) × 3 conv_2 | | |
| E | 0.286 s | 240 × 320 | (7 × 7 × 128) × 1 conv_1 | 64 × 64 | 128 → 2 |
| | | | (2 × 2) max pool | | |
| | | | (3 × 3 × 128) × 3 conv_2 | | |
| F | 0.042 s | 120 × 160 | (3 × 3 × 128) × 1 conv_1 | 32 × 32 | 128 → 2 |
| | | | (2 × 2) max pool | | |
| | | | (3 × 3 × 128) × 3 conv_2 | | |
| G | 0.036 s | 120 × 160 | (5 × 5 × 128) × 1 conv_1 | 32 × 32 | 128 → 2 |
| | | | (2 × 2) max pool | | |
| | | | (3 × 3 × 128) × 3 conv_2 | | |
| H | 0.037 s | 120 × 160 | (5 × 5 × 64) × 1 conv_1 | 32 × 32 | 128 → 2 |
| | | | (2 × 2) max pool | | |
| | | | (3 × 3 × 64) × 3 conv_2 | | |
| I | 0.037 s | 120 × 160 | (5 × 5 × 64) × 1 conv_1 | 32 × 32 | 128 → 2 |
| | | | (2 × 2) max pool | | |
| | | | (3 × 3 × 64) × 3 conv_2 | | |
| J | 0.033 s | 60 × 80 | (5 × 5 × 64) × 1 conv_1 | 16 × 16 | 128 → 2 |
| | | | (2 × 2) max pool | | |
| | | | (3 × 3 × 64) × 3 conv_2 | | |

Note that the “conv_1” and “conv_2” layers shown in the table correspond to the sequences Conv-ReLU-CN and Conv-BN-ReLU, respectively. Further, all the convolution layers run with stride one.

TABLE 2
Experimental results of finding the best architecture of RPN.

| Overlap range | | MinBox sizes | Box pyramid scale | NumBox pyramid levels | Precision | Recall |
|---|---|---|---|---|---|---|
| A | $[ \begin{matrix}0 , & 0.3 ; \\ 0.7 , & 1\end{matrix} ]$ | [125, 125] | 1.1 | 9 | 0.9810 | 0.9793 |
| B | $[ \begin{matrix}0 , & 0.3 ; \\ 0.7 , & 1\end{matrix} ]$ | [125, 125] | 1.1 | 9 | 0.9489 | 0.9568 |
| C | $[ \begin{matrix}0 , & 0.3 ; \\ 0.7 , & 1\end{matrix} ]$ | [125, 125] | 1.1 | 9 | 0.9922 | 0.9918 |
| D | $[ \begin{matrix}0 , & 0.3 ; \\ 0.7 , & 1\end{matrix} ]$ | [125, 125] | 1.1 | 9 | 0.9900 | 0.9888 |
| E | $[ \begin{matrix}0 , & 0.3 ; \\ 0.7 , & 1\end{matrix} ]$ | [64, 64] | 1.1 | 9 | 0.9825 | 0.9825 |
| F | $[ \begin{matrix}0 , & 0.3 ; \\ 0.65 , & 1\end{matrix} ]$ | $[ \begin{matrix}32 , & 32 ; \\ 48 , & 32\end{matrix} ]$ | 1.2 | 5 | 0.9737 | 0.9800 |
| G | $[ \begin{matrix}0 , & 0.3 ; \\ 0.65 , & 1\end{matrix} ]$ | $[ \begin{matrix}32 , & 32 ; \\ 48 , & 32\end{matrix} ]$ | 1.2 | 5 | 0.9762 | 0.9778 |
| H | $[ \begin{matrix}0 , & 0.3 ; \\ 0.65 , & 1\end{matrix} ]$ | $[ \begin{matrix}32 , & 32 ; \\ 48 , & 32\end{matrix} ]$ | 1.2 | 5 | 0.9604 | 0.9640 |
| I | $[ \begin{matrix}0 , & 0.3 ; \\ 0.65 , & 1\end{matrix} ]$ | $[ \begin{matrix}32 , & 32 ; \\ 32 , & 48\end{matrix} ]$ | 1.2 | 5 | 0.9778 | 0.9805 |
| J | $[ \begin{matrix}0 , & 0.3 ; \\ 0.6 , & 1\end{matrix} ]$ | $[ \begin{matrix}16 , & 16 ; \\ 24 , & 16 ; \\ 16 , & 24 ; \\ 24 , & 24\end{matrix} ]$ | 1.1 | 9 | 0.9400 | 0.9398 |

“Overlap Range” is the bounding box overlap ratios for selecting negative and positive samples.
“MinBox Sizes” is the minimum anchor box sizes used to build the anchor box pyramid.
“Box Pyramid Scale” is the anchor box pyramid scale factor used to successively upscale anchor box sizes.
“NumBox Pyramid Levels” is the number of levels in an anchor box pyramid.

The initial version of the new network architectures was labeled Model A and Model B, which had only six and five convolutional layers, respectively. The experimental results showed that the performance of Model B was considerably worse than that of Model A, even when the number of neurons in the fully connected layer was increased. Next, we attempted to replace the first three layers of the network with a convolutional layer of a larger kernel size, which resulted in Models C and D. The use of multiple kernel sizes in a network helped the network to obtain more diverse features in an image. The difference between these two models was the different pooling strategies used, namely, max pooling for Model C and average pooling for Model D. Irrespective of the pooling strategy, their performance was almost 100% precision and recall. Although the models performed well, they used a large number of computed parameters in the networks and thus required a long processing time of approximately 0.3 s to complete the detection. Therefore, we reduced the size of the training set by 2×, 4×, and 8× to generate Models E, I, and J, respectively. The smaller was the size of the images used for training, the less was the time required for the model training and testing and the lower was the detection accuracy. According to the experimental results, the performance of Model J was the worst of all the models trained using images of different sizes. This might be attributed to the fact that the images used for training had very few features for the detection when they were shrunk considerably. We finally used the architecture of Model I to implement the algorithm proposed in this paper. Models F, G, and H were the parameter-adjusted results of Model I. Among them, Model I exhibited better performance and sufficiently low time consumption for the detection.

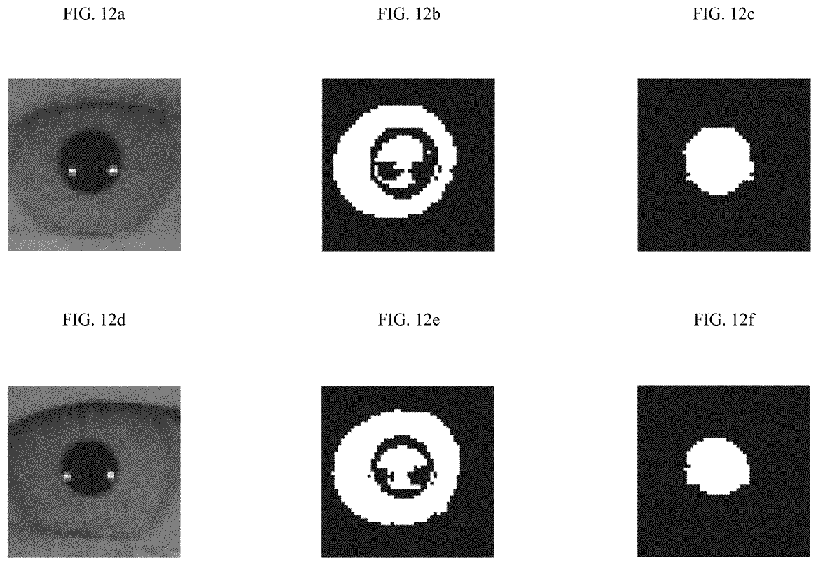

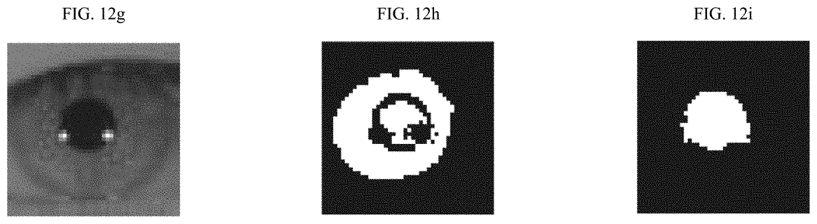

The GMM was trained using the images with the information of the pupillary region. We used the GMM to fit the potential pupillary region inside the bounding box found by Faster R-CNN. Each pixel in an image was represented by a nine-dimensional feature vector used for the training and the testing. The features consisted of the normalized coordinates of pixels, pixel values filtered by a local median of kernel size 5×5, and pixel values filtered using Gabor filters. The Gabor filters of size 5×13 were parameterized as follows: σ=2, θ=[45°, 360°], λ=1.5, γ=2.5. In the training stage, the pixels inside the pupillary region were taken as the positive samples. A normal distribution built from the pixel values of the entire region was used to remove the positive samples located in the region of the reflection points. The same number of samples as in the positive sample was selected from the pixels out of the pupillary region to form a negative sample. We also attempted to use SVM instead of GMM to predict the potential pupillary region. However, it did not perform as well as GMM, as it took more than three days for training, which was considerably much longer than GMM which only takes 5 min. Furthermore, its accuracy of region prediction was poor, as shown in FIGS. 12a-12i. FIGS. 12b, 12e, and 12h present three regions fit by SVM. And FIGS. 12c, 12f, and 12i present regions fit by GMM.

We implemented our algorithm with MATLAB R2018a and run it on a personal computer with 3.4-GHz CPUs and GTX 1080 GPU. The average time cost per eye of iris segmentation was approximately 0.06 s, which indicated that the proposed algorithm is a fast iris segmentation algorithm.

Performance Evaluation for Iris Segmentation.

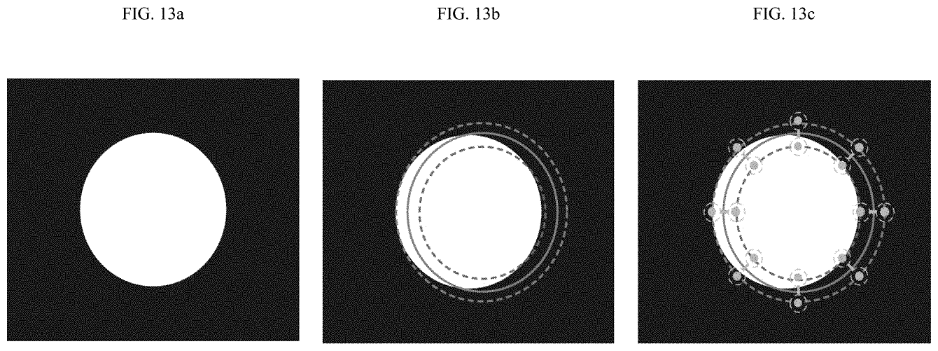

Traditionally, most researchers have evaluated the results of iris segmentation with subjective methods, for example, by reading the iris segmentation results on the plotted image and manually giving the judgment. To quantitatively estimate the performance of pupillary boundary localization and limbus boundary localization, we propose a new method based on the integration of the radial difference. For each image, we used the region information of the manually labeled iris region to generate two separate binary maps containing the pupillary region and the iris region, respectively. We assumed a segmentation S that was parameterized by the coordinates of the circle's center and its radius, denoted as a triple set r). Then, we created a dilated version S_{d}⁺ and an eroded version S_{d}⁻ of S, which was parameterized as (x_{c},y_{c},r+d) and (x_{c},y_{c},r−d), respectively. As such, every point of S had its corresponding points on S_{d}⁺ and S_{d}⁻. By collecting N pairs of corresponding points on S_{d}⁺ and S_{d}⁻ denoted as (Pᵢ⁺, Pᵢ⁻), we evaluated the performance of S by using the q value computed using Equation (6). FIGS. 13a, 13b and 13c illustrate the procedure for the performance evaluation. Among them, FIG. 13a illustrates an example of a binary map. In FIG. 13b, S (Green circle or the middle size circle), S_{d}⁺ (blue-dotted circle or the largest size circle), and S_{d}⁻ (red-dotted circle or the smallest size circle) are drawn on the binary map. The q value is the mean of the integration of the difference between the yellow point pairs in the FIG. 13c used to evaluate the segmentation performance.

$$q = \frac{{\sum }_{i = 1}^{N} ( {p}_{i}^{-} - {p}_{i}^{+} )}{N} , i ϵ [ 1 , N ] . \qquad ( 6 )$$

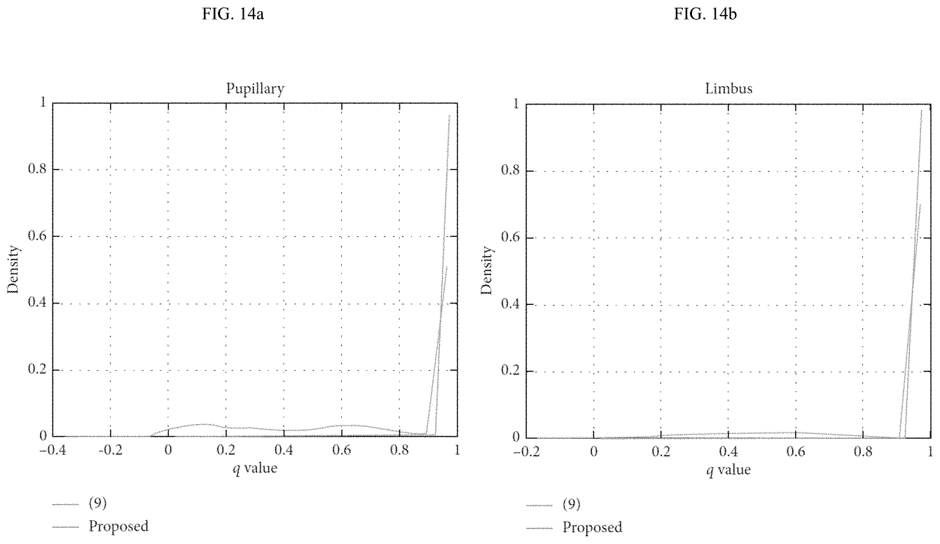

By comparing with a best known technology, the proposed performance evaluation method was used with parameters d=10(15) and N=36(36) for evaluating the performance of the pupillary (limbus) boundary localization. With such a d value, it ensured that the results of the proposed segmentation algorithm had at least a 0.5 IoU value with the ground truth. By selecting the aforementioned parameters, we make the proposed algorithm to be fast enough for a real-time iris recognition system (above 15 frames per second) while maintaining the accuracy of iris segmentation. It set q=0.9 as the threshold to select effective segmentation and computed the accuracy of segmentation with this threshold. FIGS. 14a and 14b illustrate the histogram of the q values for evaluating the segmentation performance on the full CASIA-Iris-Thousand database. As we can see, the present invention, as proposed here, performs much better than those of [9], a state-of-the-art: “An accurate and efficient user authentication mechanism on smart glasses based on Iris recognition.” The accuracy of segmentation is shown in Table 3. As depicted in Table 3, the proposed algorithm showed a dramatic increase from 47.84% to 95.49%, comparing with “An accurate and efficient user authentication mechanism on smart glasses based on Iris recognition.” This could be attributed to the fact that the method used for the localization of the eye was changed to a learning-based algorithm. As such, the parameters used to find the boundary points of the pupillary region and the iris were robustly adjusted automatically during runtime for different input images.

TABLE 3
Accuracy of the iris segmentation algorithm.

| | Proposed | [9] |
|---|---|---|
| Pupillary boundary | 96.77% | 51.60% |
| Iris boundary | 98.32% | 70.17% |
| Both boundaries | 95.49% | 47.84% |

Difference Between the Proposed Method and Other Published Methods.

There are many iris segmentation methods based on deeply learned neural networks. In this section, we discuss the difference between two state-of-the-art methods, IrisDenseNet and the model proposed by He et. al.

IrisDenseNet uses a 13-layered VGG-16 network as its core to detect actual iris area (excluding area such as eyelid and eyelashes). However, it only performs segmentation for the iris area without a proper method to normalize it. As we can know, the iris normalization is a key stage for high-performance iris recognition. If this stage is missing, there is no guarantee that the final accuracy of their iris recognition system still remains the desired precision. Also, due to its deep layers, the computation complexity of training and using it is extremely costing compared to the present invention.

Another Model also employs VGG-16 network but with some changes. Its execution time for one image is 0.112 second on a 2.6 GHz CPU and GTX970MGPU which, again, is not fast enough for a real-time iris recognition system on the embedded system. On the contrary, the present invention can perform iris localization within 0.06 seconds, which is 1.87× faster.

An aspects of present invention is that we reconstruct the CNN architecture of Faster R-CNN. This new model with only six layers could generate precisely located region proposals of the eye in the images. We then extracted the feature vectors with specific dimensions to train a GMM for fitting the potential pupillary regions. Then, the pupillary boundary was recovered through five key boundary points found by pixel scans of the rows and columns. An enhanced version of MIGREP and the boundary point selection algorithm were used to find some boundary points of the limbus region, and the limbus boundary was located by using these boundary points. To evaluate the performance of iris segmentation, we developed an evaluation method based on the integration of the radial difference. Experimental results showed the effectiveness and efficiency of the proposed iris segmentation method on the CASIA-Iris-Thousand database. The segmentation accuracy of the proposed method was 95.49%, which was higher than the accuracy of 47.84% achieved in the prior arts, and the time cost of the proposed iris segmentation procedure was only approximately 0.06 s. The results on the challenging CASIA-Iris-Thousand database showed that the proposed method is a fast and accurate iris segmentation algorithm.

The main advantage of the proposed algorithm over most of the state-of-the-art iris segmentation algorithms based on neural networks such as IrisDenseNet and the model proposed by He et al. is that it has a smaller model size which make it faster to segment iris images, which is crucial for a real-time iris recognition system or even implement it on a mobile device.

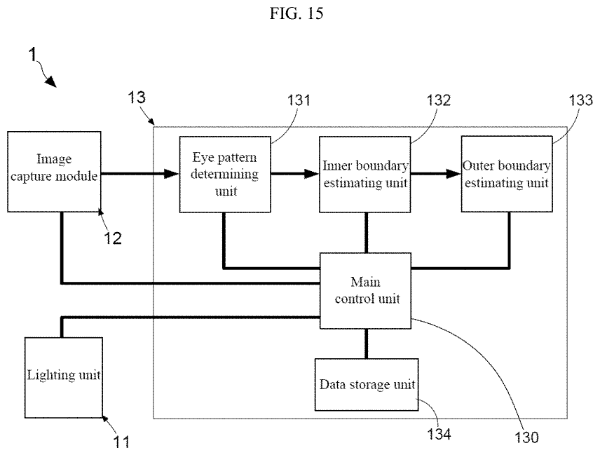

With reference to FIG. 2, there is shown a framework diagram of a system for rapidly locating iris using deep learning according to the present invention. As FIG. 2 shows, the system 1 for rapidly locating iris using deep learning mainly comprises at least one lighting unit 11, at least one image capture module 12 and a controlling and processing module 13. FIG. 15 shows a function block diagram of the system. From FIG. 15, it is understood that there are a main control unit 130, a an eye pattern determining unit 131, an inner boundary estimating unit 132 and an outer boundary estimating unit 133 provided in the controlling and processing module 13. Engineers skilled in image processing technology should know that each of the eye pattern determining unit 131, the inner boundary estimating unit 132 and the outer boundary estimating unit 132 is provided in the controlling and processing module 13 by a form of firmware, function library, application program, or operands. On the other hand, in spite of the fact that FIG. 2 depicts that the controlling and processing module 13 is a laptop PC, that is not a limitation of practical form of type of the controlling and processing module 13. Of course, the controlling and processing module 13 can also be a smart spectacles, a smart watch, a wearable virtual reality interactive device, an entrance guard device, a smart lock device, a smart phone, a tablet PC, a desk PC, or an all-in-one (AIO) PC.

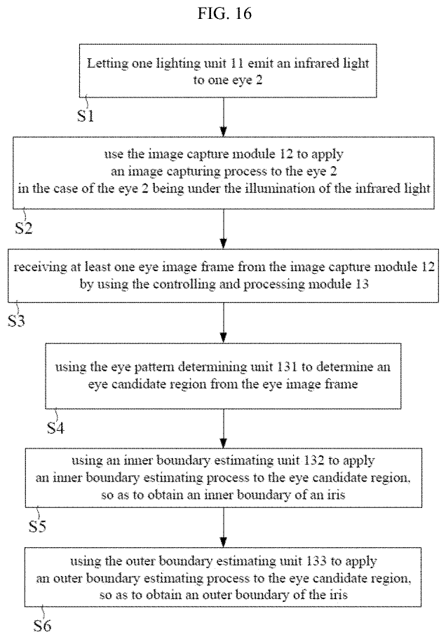

The present invention simultaneously provides a method for rapidly locating iris using deep learning, and which is implemented in the controlling and processing module 13. FIG. 16 shows a flowchart diagram of the method for rapidly locating iris using deep learning. Please simultaneously refer to FIG. 2, FIG. 15 and FIG. 16. The method firstly proceeds to steps S1 and S2, so as to let the lighting unit 11 emit an infrared light to one eye 2, and then using the image capture module 12 to apply an image capturing process to the eye 2 in the case of the eye 2 being under the illumination of the infrared light. From FIG. 2 and FIG. 15, it is understood that both the lighting unit 11 and the image capture module 12 are coupled to the controlling and processing module 13. Therefore, the lighting unit 11 and the image capture module 12 are controlled by the controlling and processing module 13 so as to complete the step S1 and the step S2.

In step S3, the controlling and processing module 13 receives at least one eye image frame from the image capture module 12. Above descriptions have indicated that the eye pattern determining unit 131, the inner boundary estimating unit 132 and the outer boundary estimating unit 133 are provided in the controlling and processing module 13 by a form of firmware, function library, application program, or operands, such that the three units certainly controlled by the main control unit 130 of the controlling and processing module 13. That is, the said main control unit 130 can be a main processor or a graphics processor integrated in the controlling and processing module 13. On the other hand, the main control unit 130 can also be a FPGA (Field programmable gate array) chip extra added into the controlling and processing module 13. Of course, there is a data storage unit 134 provided in the controlling and processing module 13.

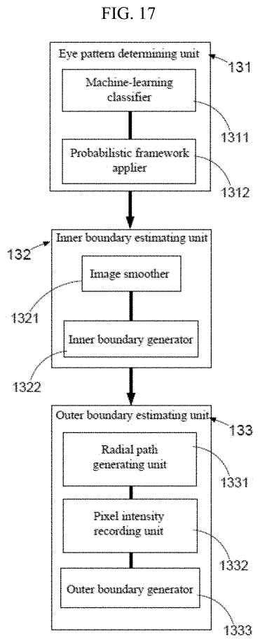

The method subsequently proceeds to step S4 for using the eye pattern determining unit 131 to determine an eye candidate region from the eye image frame. Please simultaneously refer to FIG. 17, which illustrates a diagram for describing the inner framework of an eye pattern determining unit, an inner boundary estimating unit and an outer boundary estimating unit. From FIG. 15, FIG. 16 and FIG. 17, it is able to be known that the eye pattern determining unit 131 is provided a machine-learning classifier 1311 and a probabilistic framework applier 1312 therein, wherein the machine-learning classifier 1311 is configured for finding out the eye candidate region from the eye image frame by using a machine learning algorithm. The said machine learning algorithm is selected from the group consisting of fully convolutional neural network (FCN), region-based convolutional neural network (R-CNN), mask R-CNN, fast R-CNN, faster R-CNN, single shot multibox detector (SSD), version-1 training phase of you only look once (YOLOv1), YOLOv2, and YOLOv3. Particularly, YOLO (you only look once) is a system for detecting objects on the Pascal VOC 2012 dataset.

For instance, a six-layer convolutional neural network (CNN) can be designed under the implementation of the machine learning algorithm of faster R-CNN. By using 64 of 5×5×1 convolutional filters (i.e., convolution kernels), first convolution layer is configured to apply a 5×5-pixel sub-regions extracting process to an inputted grayscale image (i.e., the eye image frame) with a stride size of 1 pixel. The 5×5×1 filter means that the convolutional filter is a one channel convolution kernel having a resolution of 5×5. Subsequently, the output images of the first convolution layer are applied with a linear rectification process and a local response normalization, so as to be converted to the inputs of a max pooling layer with 2×2 filter (i.e., pooling kernel) and stride size=2. On the other hand, each of second convolution layer, third convolution layer, and fourth convolution layer is configured to apply a 3×3-pixel sub-regions extracting process to their inputted grayscale image by using 64 of 3×3×64 filters. Moreover, in fifth layer of the six-layer CNN, a RoI (Region of Interest) pooling process is applied to extract feature vectors having a fixed dimension of 1024 from each of regions. Consequently, the extracted feature vectors are inputted into a fully connected layer (i.e., sixth layer).

Briefly speaking, when the step S4 is executed, the eye pattern determining unit 131 is controlled by the main control unit 130, so as to activate the machine-learning classifier 1311 thereof to find out an eye candidate region from the eye image frame by using a specific machine learning algorithm such as faster R-CNN. After that, the probabilistic framework applier 1312 of the eye pattern determining unit 131 is next activated for applying a pixel-level prediction process to the eye candidate region by using a Gaussian mixture model, such that a pupil candidate region is found out from the eye candidate region. However, in certain special cases, the pupil candidate region determined by the probabilistic framework applier 1312 would contain eyelashes, eyelids and noise points besides the pupil of the eye 2. For this reason, steps S5 and S6 are arranged in the method of the present invention in order to precisely find out an iris region by determining an inner boundary and an outer boundary of the iris. As FIG. 15, FIG. 16 and FIG. 17 show, the inner boundary estimating unit 132 is used to apply an inner boundary estimating process to the eye candidate region in the step S5, so as to obtain the inner boundary of the iris.

The inner boundary estimating unit 132 has an image smoother 1321 and an inner boundary generator 1322. During the execution of the step S5, it firstly uses the image smoother 1321 to apply a cluster analysis process, an empty space filling process, and a morphological process using a morphological opening operator to the pupil candidate region in turns, so as to obtain a pupil region from the pupil candidate region. After that, the inner boundary generator 1322 is subsequently adopted for firstly calculating a radius parameter based on the pupil region, and then depicting the inner boundary of the iris on the pupil region. It needs to further explain that, the cluster analysis process is completed by using a k-means algorithm, and the morphological process is completed by using at least one square structuring element to achieve a morphological operation of the pupil candidate region. FIG. 5 shows several image frames, wherein column (a) in FIG. 5 contains three images transmitted from the machine-learning classifier 1311. Moreover, column (b) in FIG. 5 also contains three images, which are outputted by the probabilistic framework applier 1312, and it can observe that the pupil candidate region determined by the probabilistic framework applier 1312 contains eyelashes, eyelids and noise points besides the pupil of the eye 2. By using the image smoother 1321 to apply i) the cluster analysis process, ii) the empty space filling process, and iii) the morphological process to the pupil candidate region in turns, three images arranged in column (c) of FIG. 5 show that the pupil region has been be clearly presented in the pupil candidate region.

FIG. 6 shows three images for describing a depicting process of the inner boundary of the iris. As image (a) of FIG. 6 shows, it is able to calculate a center point of a pupil region after the pupil region is drawn. Moreover, as image (b) of FIG. 6 shows, it looks up each of pixel values along a first horizontal line passing through the center point of the pupil region and a first vertical line passing through the center point, and then records three pixel values of left boundary point, right boundary point and down boundary point. It is worth noting that, if the upper boundary point is shielded by upper eyelid, it does not record the pixel value of the upper boundary point during looking up each of pixel values along the first horizontal line and the first vertical line. Alternatively, it may look up each of pixel values again along a second horizontal line parallel with the first horizontal line. As image (c) of FIG. 6 shows, there is a distance between the first horizontal line and the second horizontal line, which is half of the pupil region's radius. Therefore, pixel values of two auxiliary boundary points of the second horizontal line are recorded. Similarly, if the lower boundary point is shielded by the lower eyelid, it does not record the pixel value of the lower boundary. It may look up each of the pixel values again along a third horizontal line passing through another two specific points. The distance between the third horizontal line and the first horizontal line may be up to any value less than the pupil region's radius, which depends on how much area is shielded by an eyelid. Additionally, a second or third vertical line may be adopted to calculate pixel values passing through other points along the pupil's boundary. More horizontal or vertical lines may be adopted to calculate more pixel values to output a more accurate pupil region if necessary.

Following on from the previous descriptions, in one embodiment, there are five boundary points (i.e., N=5) are picked up from the pupil region, and each of the five boundary points has a corresponding pixel coordinate (xᵢ,yᵢ). Subsequently, the inner boundary generator 1322 is activated to calculate a radius parameter by using a radius parameter calculating algorithm, so as to subsequently depict an inner boundary of the iris along the outer edge of the pupil region. The radius parameter calculating algorithm is presented as following mathematic Equation (4):

$$\{ x , y , r \} = arg {min}_{x , y , r} {\sum }_{i = 1}^{N} {( {x}_{i} - x )}^{2} + {( {y}_{i} - y )}^{2} - {( {r}_{i} - r )}^{2} \qquad ( 4 )$$

After the step S5 is finished, the method of the present invention next proceeds to step S6 for using the outer boundary estimating unit 133 to apply an outer boundary estimating process to the eye candidate region, so as to obtain an outer boundary of the iris. Particularly, the present invention makes the outer boundary estimating unit 133 has a radial path generating unit 1331, a pixel intensity recording unit 1332 and an outer boundary generator 133. FIG. 10 shows six images for describing a depicting process of the outer boundary of the iris. As images (a), (b), (c), (d), and (e) of FIG. 10 show, firstly, the radial path generating unit 1331 is adopted for drawing a plurality of radial paths on the inner boundary of the iris and the pupil region, wherein each of the radial paths has a start terminal located at the inner boundary and an end terminal in a sclera region of the eye candidate region. Subsequently, as image (e) of FIG. 10 shows, the pixel intensity recording unit is used to record a plurality of pixel intensity values along each of the plurality of radial paths, so as to find out a specific point having a maximum gradient of pixel intensity from the each of the plurality of radial paths. All those specific points are used to calculate a plurality of boundary points of outer boundary of the iris. Consequently, as image (f) of FIG. 10 shows, the outer boundary generator 1333 is configured for firstly filtering out any error point from the plurality of the outer boundary points of iris, and then replace the error point by a reference point, such that the outer boundary generator 1333 is able to depict the outer boundary of the iris on the pupil region according to the plurality of the boundary points.

Therefore, through above descriptions, all embodiments and their constituting elements of the system for rapidly locating iris using deep learning proposed by the present invention have been introduced completely and clearly; in summary, the present invention includes the advantages of:

(1) The present invention provides a system and method for rapidly locating iris using deep learning, wherein the system 1 mainly comprises a lighting unit 11, an image capture module 12 and a controlling and processing module 13. Particularly, there are an eye pattern determining unit 131, an inner boundary estimating unit 132 and an outer boundary estimating unit 133 provided in the controlling and processing module 13. Moreover, the eye pattern determining unit 1331 is used for determining an eye candidate region from an eye image frame, and the inner boundary estimating unit 1332 and the outer boundary estimating unit 1333 are configured for respectively determining an inner boundary and an outer boundary of an iris. It is worth particularly explaining that, experimental data have proved that, the system 1 of the present invention is able to find out and locate an iris region from an image frame containing an eye pattern within 0.06 seconds by an accuracy of at least 95.49%.

Aspects of the present disclosure are described in a research article “An Efficient and Robust Iris Segmentation Algorithm Using Deep Learning”. The article appears as an appendix of the Taiwan Patent Application No. 108112339 and the contents of which are incorporated herein by reference.

The above description is made on embodiments of the present invention. However, the embodiments are not intended to limit scope of the present invention, and all equivalent implementations or alterations within the spirit of the present invention still fall within the scope of the present invention.

What is claimed is:

1. A system for rapidly locating iris using deep learning, comprising:
at least one lighting unit for emitting an infrared light to at least one eye;
at least one image capture module, being adopted for applying an image capturing process to the at least one eye in the case of the at least one eye being under the illumination of the infrared light; and
a controlling and processing module, being coupling to the at least one lighting unit and the at least one image capture module, so as to receive at least one eye image frame transmitted from the image capture module; the controlling and processing module comprising:
an eye pattern determining unit for determining an eye candidate region from the eye image frame;
an inner boundary estimating unit, being coupled to the eye pattern determining unit, and being configured for applying an inner boundary estimating process to the eye candidate region, so as to determine an inner boundary of an iris; and
an outer boundary estimating unit, being coupled to the inner boundary estimating unit, and being configured for applying an outer boundary estimating process to the eye candidate region, so as to determine an outer boundary of the iris.

2. The system of claim 1, wherein the controlling and processing module is selected from the group consisting of a smart spectacles, smart watch, wearable virtual reality interactive device, entrance guard device, smart lock device, smart phone, tablet PC, laptop PC, desk PC, and all-in-one (AIO) PC.

3. The system of claim 1, wherein each of the eye pattern determining unit, the inner boundary estimating unit and the outer boundary estimating unit is provided in the controlling and processing module by a form of firmware, function library, application program, or operands.

4. The system of claim 1, wherein the eye pattern determining unit comprises:
a machine-learning classifier, being configured for finding out the eye candidate region from the eye image frame by using a machine learning algorithm; and
a probabilistic framework applier, being coupled to the convolutional-neural-network-based classifier, and being configured for applying a pixel-level prediction process to the eye candidate region by using a Gaussian mixture model, so as to find out a pupil candidate region from the eye candidate region.

5. The system of claim 4, wherein the inner boundary estimating unit comprises:
an image smoother, being coupled to the probabilistic framework applier, and being configured for applying a cluster analysis process, an empty space filling process, and a morphological process using a morphological opening operator to the pupil candidate region in turns, so as to obtain a pupil region from the pupil candidate region; and
an inner boundary generator, being coupled to the image smoother, and being configured for firstly calculating a radius parameter based on the pupil region, and subsequently depicting the inner boundary of the iris on the pupil region.

6. The system of claim 4, wherein the machine learning algorithm is selected from the group consisting of fully convolutional neural network (FCN), region-based convolutional neural network (R-CNN), mask R-CNN, fast R-CNN, faster R-CNN, single shot multibox detector (SSD), version-1 training phase of you only look once (YOLOv1), YOLOv2, and YOLOv3.

7. The system of claim 5, wherein the outer boundary estimating unit comprises:
a radial path generating unit, being configured for drawing a plurality of radial paths on the inner boundary of the iris and the pupil region, wherein each of the radial paths has a start terminal located at the inner boundary and an end terminal in a sclera region of the eye candidate region;
a pixel intensity recording unit, being configured for recording a plurality of pixel intensity values along each of the plurality of radial paths, so as to find out a specific point having a maximum gradient of pixel intensity from the each of the plurality of radial paths, and then a plurality of boundary points being obtained; and
an outer boundary generator, being configured for filtering out of at least one error point from the plurality of the boundary points, so as to subsequently replace the error point by a reference point, such that the outer boundary generator depicts the outer boundary of the iris on the pupil region according to the plurality of the boundary points.

8. The system of claim 5, wherein the cluster analysis process is completed by using a k-means algorithm, and the morphological process being completed by using at least one square structuring element to achieve a morphological operation of the pupil candidate region.

9. The system of claim 5, wherein the inner boundary generator is provided a radius parameter calculating algorithm therein, and the radius parameter calculating algorithm being presented as following mathematic formula:
$$\{ x , y , r \} = arg {min}_{x , y , r} {\sum }_{i = 1}^{N} {( {x}_{i} - x )}^{2} + {( {y}_{i} - y )}^{2} - {( {r}_{i} - r )}^{2} ;$$
wherein r and (x, y) are the radius parameter and a coordinate position at the inner boundary, respectively.

10. A method for rapidly locating iris using deep learning, comprising following steps:
(1) letting at least one lighting unit emit an infrared light to at least one eye;
(2) using at least one image capture module to apply an image capturing process to the at least one eye under the at least one eye being in the illumination of the infrared light;
(3) providing a controlling and processing module having an eye pattern determining unit, an inner boundary estimating unit and an outer boundary estimating unit, and receiving at least one eye image frame from the image capture module by using the controlling and processing module;
(4) determining an eye candidate region from the eye image frame by using the eye pattern determining unit;
(5) using the inner boundary estimating unit to apply an inner boundary estimating process to the eye candidate region, so as to obtain an inner boundary of an iris; and
(6) using the outer boundary estimating unit to apply an outer boundary estimating process to the eye candidate region, so as to obtain an outer boundary of the iris.

11. The method of claim 10, wherein the controlling and processing module is selected from the group consisting of smart glasses, smart watch, wearable virtual reality interactive device, entrance guard device, smart lock device, smart phone, tablet PC, laptop PC, desk PC, and all-in-one (AIO) PC.

12. The method of claim 10, wherein the eye pattern determining unit has a machine-learning classifier and a probabilistic framework applier, and the step (4) comprising following detail steps:
(41) using the machine-learning classifier to find out the eye candidate region from the eye image frame by using a machine learning algorithm;
(42) using the probabilistic framework applier to apply a pixel-level prediction process to the eye candidate region by using a Gaussian mixture model, so as to find out a pupil candidate region from the eye candidate region.

13. The method of claim 12, wherein the inner boundary estimating unit has an image smoother and an inner boundary generator, and the step (5) comprising following detail steps:
(51) using the image smoother to apply a cluster analysis process, an empty space filling process, and a morphological process using a morphological opening operator to the pupil candidate region in turns, so as to obtain a pupil region from the pupil candidate region; and
(52) using the inner boundary generator to firstly calculate a radius parameter based on the pupil region, and then depict the inner boundary of the iris on the pupil region.

14. The method of claim 12, wherein the machine learning algorithm is selected from the group consisting of fully convolutional neural network (FCN), region-based convolutional neural network (R-CNN), mask R-CNN, fast R-CNN, faster R-CNN, single shot multibox detector (SSD), version-1 training phase of you only look once (YOLOv1), YOLOv2, and YOLOv3.

15. The method of claim 13, wherein the outer boundary estimating unit has a radial path generating unit, a pixel intensity recording unit and an outer boundary generator, and the step (6) comprising following detail steps:
(61) using the radial path generating unit to draw a plurality of radial paths on the inner boundary of the iris and the pupil region, wherein each of the radial paths has a start terminal located at the inner boundary and an end terminal in a sclera region of the eye candidate region;
(62) using the pixel intensity recording unit to record a plurality of pixel intensity values along each of the plurality of radial paths, so as to find out a specific point having a maximum gradient of pixel intensity from the each of the plurality of radial paths, and then a plurality of boundary points being obtained; and
(63) using the outer boundary generator to firstly filter out of at least one error point from the plurality of the boundary points, and then replace the error point by a reference point, such that the outer boundary generator subsequently depicts the outer boundary of the iris on the pupil region according to the plurality of the boundary points.

16. The method of claim 13, wherein the cluster analysis process is completed by using a k-means algorithm, and the morphological process being completed by using at least one square structuring element to achieve a morphological operation of the pupil candidate region.

17. The method of claim 13, wherein the inner boundary generator is provided a radius parameter calculating algorithm therein, and the radius parameter calculating algorithm being presented as following mathematic formula:
$$\{ x , y , r \} = arg {min}_{x , y , r} {\sum }_{i = 1}^{N} {( {x}_{i} - x )}^{2} + {( {y}_{i} - y )}^{2} - {( {r}_{i} - r )}^{2} ;$$
wherein r and (x, y) are the radius parameter and a coordinate position at the inner boundary, respectively.

18. A method for rapidly locating iris using deep learning, comprising:
detecting eye in an image, by an image detecting unit, to generate a potential regions of the eye, with a networking containing six layers in an order of a convolution lawyer filtered a grayscale input image, a rectified linear unit layer, a local response normalization lawyer, a maxpooling layer, a batch normalization layer, and a rectified linear unit layer;
training a Gaussian Mixture Model by using an EM algorithm consisting of two steps: (1) calculating an expectation of a component for each datum with given model parameters; and (2) maximizing the expectation with respected to the model parameters and updating the values of the model parameters;
estimating a pupillary region by (1) selecting a pupillary region based on a predetermined manner after grouping regions on candidate pixels predicted from the Gaussian Mixture Model; (2) filling any empty space inside the region selected from (1); and smoothening the region by a morphological opening operator;
locating the pupillary boundary by obtaining an approximate circle through a parameter of a center point of the pupillary region estimated and at least one boundary point;
estimating a limbus boundary by locating a plurality of positions that exhibiting maximal variation of pixel intensity based on a record of a plurality of pixel intensity values along a plurality of emitting paths going outward from the center point of the pupillary boundary; and
transmitting the limbus boundary estimated to at least one user over a communication channel.

19. A method according to claim 18, wherein estimating a limbus boundary by locating a plurality of positions that exhibiting maximal variation of pixel intensity based on a record of a plurality of pixel intensity values along a plurality of emitting paths going outward from the center point of the pupillary boundary comprising:
recording a median value of all distances of the plurality of positions to the center points of the pupillary boundary as a reference value;
drawing an additional emitting path going outward from the center point of the pupillary boundary having a different parameter set with the plurality of emitting paths;
recording corresponding distance values from the center point of the pupillary boundary to all points having a local maximal gradient;
selecting points that having both a larger local maximal gradient value and the distance value is within the reference value; and
updating the median value with the points newly selected.
